(19) United States
(12) Patent Application Publication
(10) Pub. No.: US 2016/0070748 A1
(43) Pub. Date: Mar. 10, 2016

(54) METHOD AND APPARATUS FOR IMPROVED SEARCHING OF DIGITAL CONTENT

(71) Applicant: Crimson Hexagon, Inc., Boston, MA (US)

(72) Inventors: Aykut Firat, Cambridge, MA (US); Mitchell Brooks, Boston, MA (US); Christopher Bingham, Cambridge, MA (US); Francesco Liuzzi, Boston, MA (US)

(73) Assignee: Crimson Hexagon, Inc., Boston, MA (US)

(21) Appl. No.: 14/846,148

(22) Filed: Sep. 4, 2015

Related U.S. Application Data
(60) Provisional application No. 62/045,922, filed on Sep. 4, 2014.

(51) Int. Cl. G06F 17/30

(52) U.S. Cl. CPC G06F 17/30395; G06F 17/30867; G06F 17/3053; G06F 17/30528; G06F 17/30554

(57) ABSTRACT

Improved searching of digital content using a large corpus of content collected from content generating websites is described. A search query received from a user is compared to the collected content to determine how often the elements of the search query are repeated in the collected content and whether these elements have frequently co-occurred with other elements in the content. Co-occurring elements are presented to the user so that the user can select one or more elements that best describe her intent in conducting the search. An updated search query is formed based on the information received from the user. The updated query is used to retrieve a number of documents and the retrieved documents are classified to distinguish relevant documents from those irrelevant to the user's intent. Documents classified as relevant are presented to the user.

### RELATED APPLICATIONS

This application claims the benefit of and priority to U.S. Provisional Application No. 62/045,922, filed on Sep. 4, 2014, the entirety of which is incorporated herein by reference.

### FIELD OF INVENTION

The present invention generally relates to a computer implemented method and corresponding computer program product for improved searching of digital content.

### BACKGROUND

Retrieving relevant documents from a large corpus of data is often a challenging task. Traditional search engines often require users of their search engines (hereinafter “searchers”) to enter one or more keywords to initiate a search query. The terms used by searchers do not always lead the users to their desired results, requiring the searchers to repeat their searches with new or modified keywords. Some search engines may allow searchers to narrow their searches by combining or excluding certain terms. For example, Boolean-based search engines often allow their users to use operators such as “AND,” “OR,” or “NOT” to include or exclude certain terms, and/or narrow down or expand their searches.

However, searchers may still encounter various difficulties in obtaining their desired search results. For example, searchers may lack the required skills for using Boolean search terms and/or these terms may vary among various search engines (e.g., some engines may abbreviate the “AND” and “OR” operators into “&” and “I”). Further, searchers may not know the correct keywords for their search and/or have difficulty in finding the appropriate keywords for their search query. Additionally, certain keyword may have multiple meanings (i.e., homonyms) and express multiple concepts, only one of which the user is interested in searching. For example, the search term “train” may be used to reference a train in its traditional sense (e.g., Amtrak train) or the musical band “train.” Furthermore, since the keyword (or keywords) included in a search query can be included in various conversations and/or documents, users will have to sift through the results or use their domain knowledge to find their desired search results.

These difficulties of traditional search engines can also complicate searching of social media content (e.g., content generated on social networking mediums such as Facebook, Instagram, Pinterest, or Twitter). For example, the social networking website, Twitter, which allows its users to send and receive messages having up to 140 characters, has hundreds of millions users generating a large corpus of content every day. Although these messages can be organized into groups or topics by use of a hashtag (created by placing the hash character (i.e., “#”) in front of a word or an unspaced phrase), searchers would still need to use the appropriate combination of keywords before they can find their desired search results.

### SUMMARY

A method, computerized system, and computer program product according to some embodiments disclosed herein relates to improved searching of digital content. The method, computerized system, and computer program product includes receiving a search query from a user, comparing the search query to digital content collected over a predetermined period of time from one or more digital content generating entities and determining frequency of occurrence of the search query over the collected digital content. Attributes of portions of the collected digital content in which the search query frequently occurs are presented to the user and a selection of the presented attributes is received from the user. An updated search query is constructed based on the selection of the attribute.

In other examples, any of the aspects above, or any system, method, apparatus, and computer program product method described herein, can include one or more of the following features.

The collected digital content can be collected by accessing the one or more digital content generating entities and collecting at least a portion of entire content generated by the digital content generating entities over the predetermined period of time. The collected digital content can include at least a portion of a digital text, a digital audio file, a digital image, a digital document, a digital file, or combination thereof.

The collected digital content can be analyzed to determine one or more digital text elements with which a given digital text member of collected content often co-occurs. The one or more digital text elements with which the given digital text member of collected content often co-occurs can be ranked based on a frequency at which the given digital text and each of the one or more digital text elements co-occur.

Each digital text element of collected digital content can be organized into a word network based on number of times that digital text element is repeated along with other digital text elements of the collected digital content, or based on a word-vector similarity. The nodes of the word network can connect similar digital text elements to one another. Clusters of nodes, identifying digital text elements used in similar contexts in the collected digital content, in the word network can be identified. The attributes of portions of the collected digital content can include attributes of the identified clusters. The selection made by the user can identify one or more clusters that best correspond to the user's search query.

The search query can include one or more digital text elements and the frequency of occurrence of the search query over the digital content can be determined by at least one of determining the frequency at which each text element of the search query occurs over the collected digital content or determining the frequency at which each text element of the search query co-occurs with other digital elements of the collected digital content. The attributes of portions of the collected digital content presented to the user can include at least a segment of digital elements of the portions of the collected digital content with which a text element of the search query frequently co-occurs.

The updated search query can be a Boolean search query constructed based on the selection made by the user. One or more pieces of the collected digital content can be retrieved using the updated search query and portions of the retrieved pieces of collected digital content that are relevant to the user's search query can be distinguished from the retrieved pieces. The relevant portions of the retrieved pieces can be presented to the user.

Other aspects and advantages of the invention can become apparent from the following drawings and description, all of which illustrate the principles of the invention, by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of an example information retrieval system that can be used with the embodiments disclosed herein.

FIG. 2 is an example illustration of digital electronic circuitry or computer hardware that can be used with the embodiments disclosed herein.

FIG. 3 is a block diagram of an example interface for retrieving information that can be used with the embodiments disclosed herein.

FIG. 4 is a simplified flow diagram of the procedures that can be used by embodiments disclosed herein for generating information based on an entire corpus of collected content.

FIG. 5 is a simplified flow diagram of the procedures that can be used by embodiments disclosed herein for assisting a user with conducting a document search.

### DETAILED DESCRIPTION

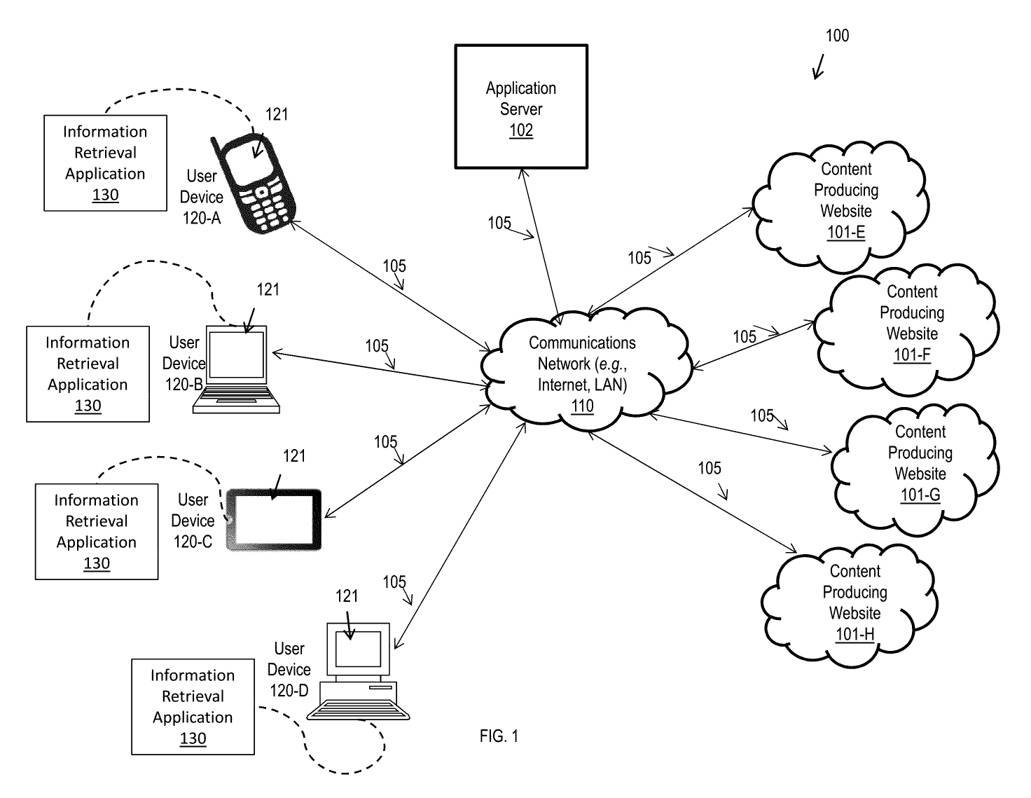

FIG. 1 is a block diagram of an example information retrieval system 100 that can be used with the embodiments disclosed herein. The information retrieval system 100 can include an application server 102 that connects to various content producing websites 101-E, 101-F, 101-G, 101-H via a communications network 110. The application server 102 can also connect with a number of user communications devices 120-A, 120-B, 120-C, 120-D (hereinafter “user devices”) via the communications network 110. The application server 102, user communications devices 120-A, 120-B, 120-C, 120-D, and the content producing websites 101-E, 101-F, 101-G, 101-H can connect to the communications network 110 via a number of communications links 105. The communications links 105 can be wired or wireless links.

The communications network 110 can be a public network (e.g., the Internet), a private network (e.g., local area network (LAN)), a wide area network (WAN), or a metropolitan area network (MAN). Alternatively or additionally, the communications network 110 can be a hybrid communications network that includes all or parts of other networks. The communications network 110 can have various topologies (e.g., star, bus, or ring network topologies).

The content producing entities or websites 101-E, 101-F, 101-G, 101-H (hereinafter collectively “content producing websites”) can include any entity that generates digital content. The generated digital content can be any type of digital content including, but not limited to, digital text, digital audio, digital images, or any other type of digital media known in the art. For example, the content producing websites 101-E, 101-F, 101-G, 101-H can include a website, a blog, or a social networking website, such as Facebook, Instagram, Pinterest, Twitter, or a combination thereof.

The application server 102 accesses the content produced by the content producing websites 101-E, 101-F, 101-G, 101-H periodically, analyzes, and processes the content generated by these websites. For example, the application server 102 can access a content generating website (e.g., Twitter) to retrieve and process content generated over a predetermined amount of time (e.g., content produced on Twitter over the span of the last 24 hours).

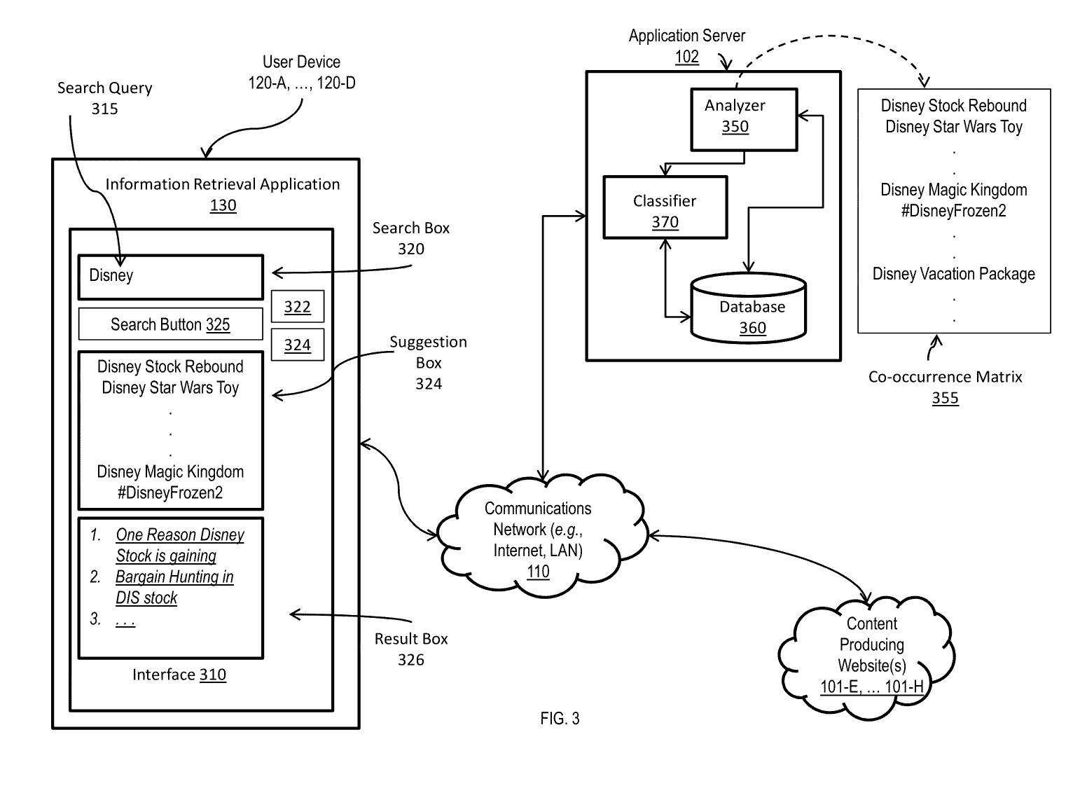

The application server 101 can include a database 360 (shown in FIG. 3) that stores the information retrieved from the content producing websites 101-E, 101-F, 101-G, 101-H. The database 360 can store the retrieved information as raw information (e.g., actual content), processed information (e.g., content processed by the application server), and/or as a combination of both raw and processed information.

The application server 102 can further maintain (e.g., store) other information in the database 360. For example, the application server 102 can maintain information regarding user devices 120-A, 120-B, 120-C, 120-D that access the application server 102, information regarding devices that have registered with the application server 102 or a listing of such devices, registration information relating to users of such registered devices, information that can be used to identify the user devices (e.g., Internet Protocol (IP) addresses, etc.), information regarding the content producing websites 101-E, 101-F, 101-G, 101-H that are accessed, information regarding preferred content producing websites and/or their preferred users, etc.

The user devices 120-A, 120-B, 120-C, 120-D can be any type of a communications device that is capable of establishing a connection to a communication network 110 and/or other communications devices. Examples of the user devices that can be used with the embodiments described herein include, but are not limited to, wireless phones, smart phones, desktop computers, workstations, tablet computers, laptop computers, handheld computers, personal digital assistants, etc.

Each user device 120-A, 120-B, 120-C, 120-D can have a screen 121 that may be used to receive and display information. The screen 121 can be a touch screen. Each user device 120-A, 120-B, 120-C, 120-D can further include an information retrieval application 130 that can be used for searching content generated by one or more of the content producing websites 101-E, 101-F, 101-G, 101-H and retrieving information. For example, the information retrieval application 130 can be used to search content produced on a social networking website (e.g., Twitter) to retrieve information relating to one or more keywords entered by the user into an interface 310 (shown in FIG. 3) of the information retrieval application 130.

The information retrieval application 130 can be presented to a user (not shown) of a user device 120-A, 120-B, 120-C, 120-D using a user interface 310, such as a graphical user interface. The information retrieval application 130 can be presented to the user using application software that provides an interactive medium for receiving input from the user. The information retrieval application 130 can be a web-based platform. Alternatively or additionally, user device 120-A, 120-B, 120-C, 120-D can access the information retrieval application 130 through an interactive medium provided by the application software or using the web-based interface.

The interface 310 of the information retrieval application 130 can include a search box 320 (shown in FIG. 3), into which the user can enter a query 315 (shown in FIG. 3). Upon receiving the search query 315, the information retrieval application 130 connects to the application server 102 through the communications network 110 and communicates the search query 315 to the application server 102. In response, the application server 102 can facilitate the user's search and retrieval of information, for example by expanding the user's search (e.g., by suggesting additional keywords) and/or contracting the user's search (e.g., in the event the keyword contains a homonym analyzing the user's search to determine which meaning of the word the user intends to search for and limiting the field of search accordingly). Once the expansion or/and the contraction of the search query 315 is completed, the application server 102 generates a final search query that can be used to retrieve the user's desired results. The application server 102 uses this final search query to retrieve content corresponding to the final search query. The retrieved content is presented to the user via the interface 310 of the information retrieval application 130. Alternatively or additionally, in some embodiments, the interface 310 of the information retrieval application 130 can present to the user the final search query used to retrieve the content.

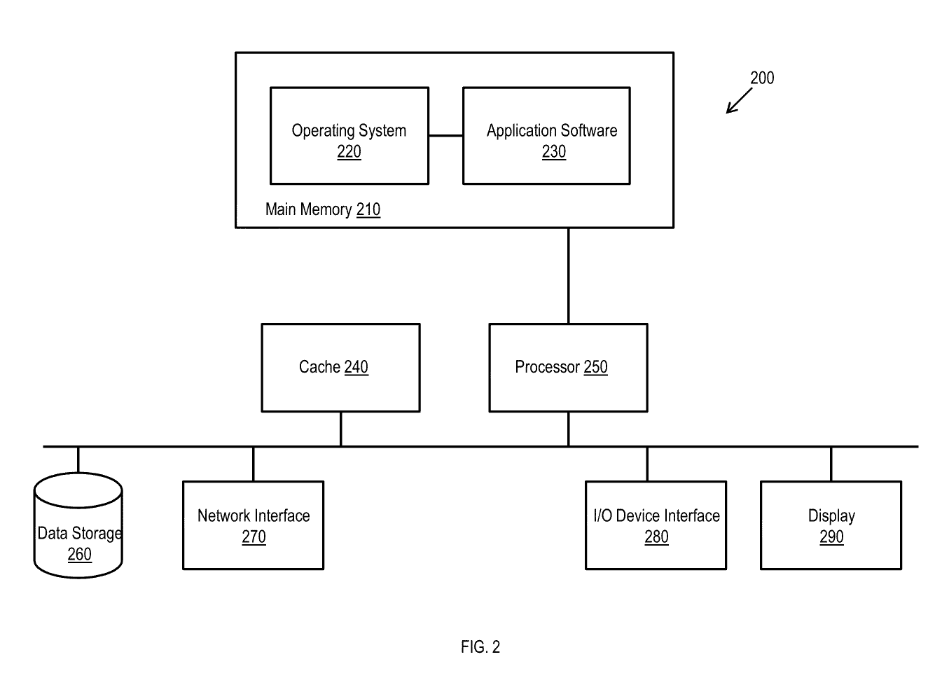

FIG. 2 is an example illustration of digital electronic circuitry 200 or computer hardware that can be used with the embodiments disclosed herein, for example the digital circuitry associated with the application server 102. The techniques described herein, without limitation, can be implemented in digital electronic circuitry or in computer hardware that executes software, firmware, or combinations thereof. The implementation can be as a computer program product, for example a computer program tangibly embodied in a machine-readable storage device, for execution by, or to control the operation of, data processing apparatus, for example a computer, a programmable processor, or multiple computers.

The program codes that can be used with the embodiments disclosed herein. For example the program codes associated with the information retrieval application 130 can be implemented and written in any form of programming language, including compiled or interpreted languages, and it can be deployed in any form, including as a stand-alone program or as a component, subroutine, module, or other unit suitable for use in a computing environment. A computer program can be deployed to be executed on one computer or on multiple computers at one site or distributed across multiple sites and interconnected by a communications network.

One or more programmable processors can execute a computer program to operate on input data, perform function and method steps described herein, and/or generate output data. An apparatus can be implemented as, and method steps can also be performed by, special purpose logic circuitry, such as a field programmable gate array (FPGA) or an application specific integrated circuit (ASIC). Modules can refer to portions of the computer program and/or the processor/special circuitry that implements that functionality.

The digital electronic circuitry 200 can include a main memory unit 210. The main memory 210 can include an operating system 220 and be configured to implement various conventional operating system functions. For example, the operating system 220 can be responsible for memory management, controlling access to various devices, and/or implementing various functions of the digital circuitry 200. The main memory 210 can also hold application software 230. For example, the main memory 210 can include various application software, computer executable instructions, and data structures, including computer executable instructions and data structures that implement aspects of the techniques described herein.

The main memory 210 can connect to a processor 250 and, optionally, a cache unit 240 that can store copies of the data from the most frequently used main memory 210 locations. The processor 250 can include a conventional central processing unit (CPU) comprising processing circuitry that can execute various instructions and manipulate data structures from the main memory 210. For example, the processor 250 can be a general and/or special purpose microprocessor and any one or more processors of any kind of digital computer. Generally, the processor 250 will receive instructions and data from the main memory 210 (e.g., a read-only memory or a random access memory or both) and executes the instructions. The instructions and other data are generally stored in the main memory 210.

The main memory 210 can be any form of non-volatile memory included in machine-readable storage devices suitable for embodying computer program instructions and data. For example, the memory 210 can be one or more of a semiconductor memory device (e.g., EPROM or EEPROM), magnetic disk (e.g., internal or removable disks), magneto-optical disks, flash memory, CD-ROM, and/or DVD-ROM disks. The processor 250 and the main memory 210 can be included in or supplemented by special purpose logic circuitry.

The processor 250 can also be connected to various interfaces via an input/output (I/O) device interface 280. The digital electronic circuitry 200 can also include one or more data storage devices 260 and be arranged to transfer data to or receive data from the storage device 260. The digital electronic circuitry 200 can also include a network interface 270 that is responsible for providing the circuitry 200 with a connection to the communications network 110. Transmission and reception of data and instructions can occur over the communications network 110.

The digital electronic circuitry 200 can also include a display 290 for receiving and/or displaying information. The display can be a touch display and/or any type of display device known in the art.

FIG. 3 is a block diagram of an example interface 310 for retrieving information that can be used with the embodiments disclosed herein. As noted above, a user (not shown) connected to a user device 120-A, . . . , 120-D can use the information retrieval application 130 to conduct a search of the content generated on one or more content producing websites 101-E, . . . , 101-H. The interface 310 of the information retrieval application 130 can include a search box 320, into which the user can enter her search query 315. In the example shown in FIG. 3, the search query 315 is the term “Disney.” The interface can include a search button 325 that allows the user to click the search button 325 to start the search. Although not shown, the interface 310 can include a field for allowing the user to choose one or more content producing websites to conduct the search and retrieve search results. For example, the interface 310 can allow the user to select one or more social networking websites (e.g., Twitter, Facebook, etc.), blogs, websites, etc. from which search results are retrieved. The interface 310 can present the user with a list of the available content producing websites 101-E, . . . , 101-H and/or can provide the user with a field for entering her preferred content producing websites 101-E, . . . , 101-H. In some embodiments, the interface 310 can be built into the interface of a content producing websites 101-E, . . . , 101-H or implemented into a search field or a search engine included in or associated with the content producing website.

The user's search query 315 is transmitted through the communication network 110 to the application server 102. The application server 102 includes a database 360 of pre-processed information obtained from the content producing websites 101-E, . . . , 101-H. Specifically, the application server 102 accesses the content producing websites 101-E, . . . , 101-H periodically (e.g., every hour, every day, etc.) and collects content generated within a predetermined period of time. The collected information can be stored in the database 360 of the application server 102. An analyzer 350 included in the application server 102 analyzes the collected information to generate processed data indicating the frequency at which each word has been repeated across the entire corpus of collected data. For example, the application server 102 can determine the number of times each word included in the collected content is repeated over the entire collected content and/or is repeated over each piece of the collected content. In the context of Twitter, for example, the application server 102 can collect the entire content (e.g., all tweets) generated over a predetermined area (e.g., a day) and determine the number of times each word in each piece of content (i.e., tweet) is repeated over that piece of content (i.e., over that tweet) and/or over all of the collected content (i.e., over all tweets generated over the predetermined period of time).

As noted, the application server 102 can access a content generating website such as a social networking website (e.g., Twitter) periodically (e.g., at a specific time every day/night) and collect at least a portion of the content (e.g., all tweets or a portion of the tweets) generated over the span of a predetermined period of time (e.g., past 24 hours or past 12 hours).

This collected content information can be stored in the database 360 and accessed by the analyzer 350. The analyzer processes the collected content (e.g., the text included in the collected content) and assigns a value to each term included in each piece of the collected content. For example, as noted, in the context of Twitter and when handling content appearing as digital text, the analyzer 350 can review the collected content (e.g., tweets posted on Twitter over the span of past 24 hours) and identify each word included in each collected tweet. The analyzer 350 can analyze each piece of content (e.g., each tweet) independently and separately from other pieces of content (e.g., other tweets) and assign a score to each word in the analyzed piece of content using one or more scoring algorithms.

Once each content piece is analyzed, the analysis results (or analyzed data) are stored in the database 360 as raw data. Each word is assigned a frequency value that indicates the number of times that word is repeated in the entire collected content. Additionally, one or more word-vectors can be formed for each word using any technique known in the art, for example, using the “word2vec” algorithm and/or using the Global Vectors for Word Representation (GloVe) learning algorithm. Generally, word-vectors are created based on co-occurrences of words in a data corpus (collected data) and by creating a vector for each word whose components determine syntactical and semantically similarities between words.

For each word in the collected content, top most similar words to a word are calculated by using word-vectors. Top most similar words for each word are calculated based on for example the cosine similarity between their respective word vectors and stored in the database 360. Ultimately, the analyzer 350 generates a similarity matrix 355 for each extracted word. The similarity matrix 355 contains the terms in which the extracted word is included.

When a query is issued the analyzer 350 extracts at least a portion of the content (e.g., all tweets or a portion of the tweets) that match the query. For each word in the extracted content, it determines a score that measures whether the word occurs more than what is expected in comparison to its occurrence likelihood based on the entire collected data. This score can, for example, be Pointwise Mutual Information.

In the example shown in FIG. 3, the analyzer 350 has analyzed the collected content and generated a similarity matrix 355 for the word “Disney.” The entries into the similarity matrix 355 can be ranked by their frequency. For example, in the example shown in FIG. 3, content entries relating to “Disney stock rebound,” “Disney Star Wars toy,” “Disney Magic Kingdom,” and “#DisneyFrozen2” have been used more frequently than other content entries including the term “Disney” and are, as such, among the highest ranked entries in the similarity matrix 355. This matrix, along with the frequency of words, is stored in the database 360 of the application server 102.

In the example shown in FIG. 3, the user initiates a search by entering a search query 315 (e.g., “Disney”) into the search box 320 provided by the information retrieval application 130. The user can also request assistance from the information retrieval application 130 in conducting her search. For example, the user can request that the information retrieval application 130 expands or contracts her one or more words in her search query. The user can request expansion of contraction of the search query 315 by any technique known in the art. For example, the user can highlight one or more words in the search query 315 to request expansion or contraction of the highlighted word. Alternatively or additionally, the information retrieval application 130 can provide the user with a field (e.g., button or a field for entering text) for choosing expansion 322 or contraction 324 of the search query 315. The user can select the words in the search query 315 that would be expanded or contracted. For example, the user can select one or more words from the words included in the search query 315 for expansion or contraction.

If the user indicates to the information retrieval application 130 that she wishes one or more words (hereinafter “highlighted word”) from her search query 315 to be expanded, the analyzer 350 can access the database 360 to obtain a set of keywords that are most similar to the highlighted word and forward the obtained keywords to the information retrieval application 130 for presentation to the user.

For example, in the example shown in FIG. 3, the search query 315 and the user's request for expansion are communicated to the application server 102. In response, the analyzer 350 consults the database 360 to obtain the raw data corresponding to the search query 315 (e.g., “Disney”). The analyzer 335 extracts the terms that are similar to the search query 315 (e.g., “Disney Stock Rebound,” “Disney Star Wars Toy,” . . . , “Disney Magic Kingdom,” “#Disneyfrozen2,” etc.) and forwards these terms to the information retrieval application 130 for presentation to the user. If the user, then highlights a result, and wants to expand that term, the analyzer 350 consults the database 360 to obtain the most similar words to that term and displays them to the user.

The extracted similar terms can be presented to the user via the information retrieval application 130. For example, the information retrieval application 130 can include a suggestion area 324 (or a suggestion field/box), using which the extracted similar terms can be presented to the user. As shown in FIG. 3, the similar terms (hereinafter “suggested terms”) can be any combination of words, parts of words and their combinations, hashtags, etc.

The information used by the application server 102 (i.e., the content collected from content generating websites) to suggest similar terms to the user differs from the information used by available search engines in that this information is based on content generated by the content generating websites over a predetermined time period. This is in contrast with presently available search engines that use features such as the user's behavioral data (e.g., recent shopping history, recent searches, recently downloaded music genre, etc.) or other user's behavioral data (e.g., most recent searches conducted by other searchers) to suggest related searches to the users.

The user can expand her search by selecting one or more of the suggested terms (e.g., various words, combination of words, word extracts, hashtags, etc.) for expanding her search. The user's selection of the suggested terms results in creation of an undated Boolean search query that can be used by the analyzer 350 to further expand the keywords and narrow the search and/or by the classifier 370 to generate user's desired search results. The Boolean search query can be arranged such that it is completely transparent to the user.

The information retrieval application 130 can further allow the user to narrow her search by consulting the database 360 and presenting additional suggested terms. The user can continue to select the suggested term to expand her search keys.

Additionally or alternatively, the user can choose the contraction of one or more words in her search query 315. For example, the user can choose the contraction of her search query 315 by selecting one or more words from the search query, typing the words in a field, highlighting the words and selecting a contraction button 324, etc.

In the event the user indicates that she wishes to conduct contraction of one or more words in her search query 315, the information retrieval system 130 communicates this information to the application server 102. The analyzer 350 generates a word network that connects similar words in the database 360 (i.e., words previously processed using the entire data corpus) to the highlighted keyword and each other. Specifically, as noted above, since the words in the entire data corpus have already been processed and similarities determined, the analyzer can determine the words similar to the highlighted keywords via various techniques, such as by edge based similarity calculation. Alternatively or additionally, the analyzer 350 can use various text mining techniques, clustering techniques (e.g., walk trap community), and/or semantic similarity measures to determine word clusters corresponding to different contexts. For example, the analyzer can determine a cluster of words corresponding to the word “train” in the band context, and another cluster of words corresponding to the word “train” as a mode of transportation context. In conducting its analysis, the analyzer 350 can find the distance between a keyword and the words in the analyzed data corpus by using the pre-computed similarity matrix.

The analyzer 350 can employ a word network to restrict the search space for finding words that are similar to the highlighted keyword. The word network can be arranged using techniques known in the art. For example, the word network can be arranged such that the words are connected to one another based on how frequently they co-occur in the analyzed data corpus. For example, if a first word and a second word tend to co-occur more frequently together compared to the number of times the first word and a third word co-occur, the first word and the second word are closer nodes on the network (e.g., sequential or subsequent nodes) than the first and the third node (e.g., not directly connected node but indirectly connected through the network). The number of nodes in the network, n, can be a pre-specified number or a number defined and dictated by the user. The analyzer 350 can determine words that co-occur with to a highlighted word by finding the cluster of words that are positioned close to the highlighted word on the network.

Once a word network is organized, the analyzer 350 can identify clusters of co-occurring words within the network. Each cluster of words corresponds to a topic, sub-topic, related concept, or a theme in the analyzed data corpus. The analyzer 350 can also identify strongly connected clusters and distinguish these clusters from other clusters of data. The clusters can be identified by any clustering technique known in the art.

The application server 102 communicates representative information for each of the identified word clusters to the information retrieval application 130. The information retrieval application 130 can display the representative information to the user and allow the user to select a cluster in order to narrow down or contract her search space. The information retrieval application 130 can display the representative information using the suggestion box 324.

For example, assuming that the user enters the term “apple” as her search query 315, the analyzer 350 can identify various clusters of words that contain the word apple and present representative information for each of these clusters to the user. For example, the analyzer can identify three strong clusters of words, where one cluster relates to Apple Computers, another cluster relates to Granny Smith Apples, and a last cluster relates to the word “Apple” as a baby name. In response, the user can select a cluster from among the available clusters (e.g., Apple Computers), thereby limiting the search space in which her search is conducted. This can make the search process more efficient for the user since the user can choose one or more clusters to add to the search domain or choose to completely omit one or more clusters of data.

Accordingly, if the user's intention is to contract her search domain, the analyzer 350 generates a word network that connects similar words to the highlighted keyword. This can be accomplished by defining edges between the words using, for example, by finding the cosine similarity between the word vectors and also by using a network clustering algorithm (e.g., walktrap community) to highlight the different contexts. The user is presented with the clusters and can, in response, choose one or more clusters. The information retrieval application 130 responds by presenting keywords that are similar to the chosen cluster to the user.

The expansion and contraction options allow the application server 102 to arrive at a final Boolean query that can be used to retrieve user's desired results. The functions performed by the application server 102 can be completely invisible to the user and arranged such that the user only views the suggested terms or the representative information for the identified cluster. The final Boolean query can also be kept invisible to the user and arranged such that the final Boolean query is directly forwarded from the analyzer 350 to the classifier 370 for use in obtaining the user's desired search results.

Once the contraction and/or expansion functions are completed, the final Boolean query contains an accurate measure of the user's intent for initiating the search. This Boolean query is forwarded to the classifier 370 for use in obtaining the user's desired search results. Initially, the maximal query corresponding to the user's intention is executed and a document set potentially containing irrelevant documents is retrieved.

The classifier 370 is responsible, among other things, for distinguishing the results that are relevant to the user's search from the results that may be irrelevant. The classifier identifies the relevant results and classifies these results into appropriate categories. Any appropriate classifier known in the art can be used to complete the classification process. For example, a support vector machine (SVM) classifier that treats the context indicating word-vectors as support vectors and avoids explicit training can be used. The SVM classifier can classify the results by first labeling the results as either “positive” or “negative” results, with the positive results being the results (e.g., documents, articles, tweets, etc.) having higher co-occurrence rates and the negative results being the results with lower co-occurrence rates. The positive and negative results can be treated as support vectors (since words are treated as word-vectors, they can be used as support vectors for classification purposes) and used to classify the documents without any need for training other than the use of similar words and relevant clusters in the word network.

For example, for the example search query “apple computers,” positive context can include context including words such as “iPhone,” “iPad,” or “Mac,” while negative context can include words such as “fruit,” “candy,” or “food.” These terms, having been already arranged as word-vectors, can be used as support vectors to classify the document without needing any training data other than the selection of similar words and relevant clusters in the word network.

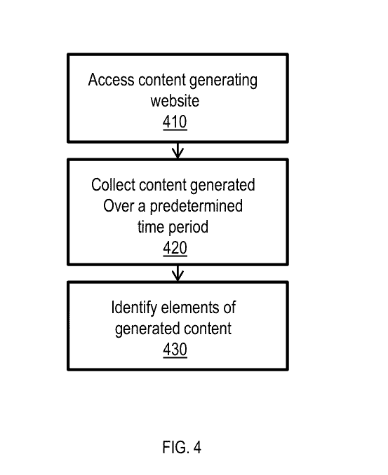

FIG. 4 is a simplified flow diagram of the procedures that may be used by embodiments disclosed herein for generating word vectors and co-occurrence information from an entire corpus of collected content.

As explained previously, the application server 102 can access one or more content generating entities/websites periodically (e.g., at a specific time every day/night) 410 and collect content generated over the span of a predetermined period of time (e.g., past 24 hours or past 12 hours) 420. The analyzer 350 can process the collected content to identify the elements of the generated content 430. The analyzer 350 can analyze each piece of content (e.g., each tweet) independently and separately from other pieces of content (e.g., other tweets) and assign a score to each word in the analyzed piece of content using one or more scoring algorithms.

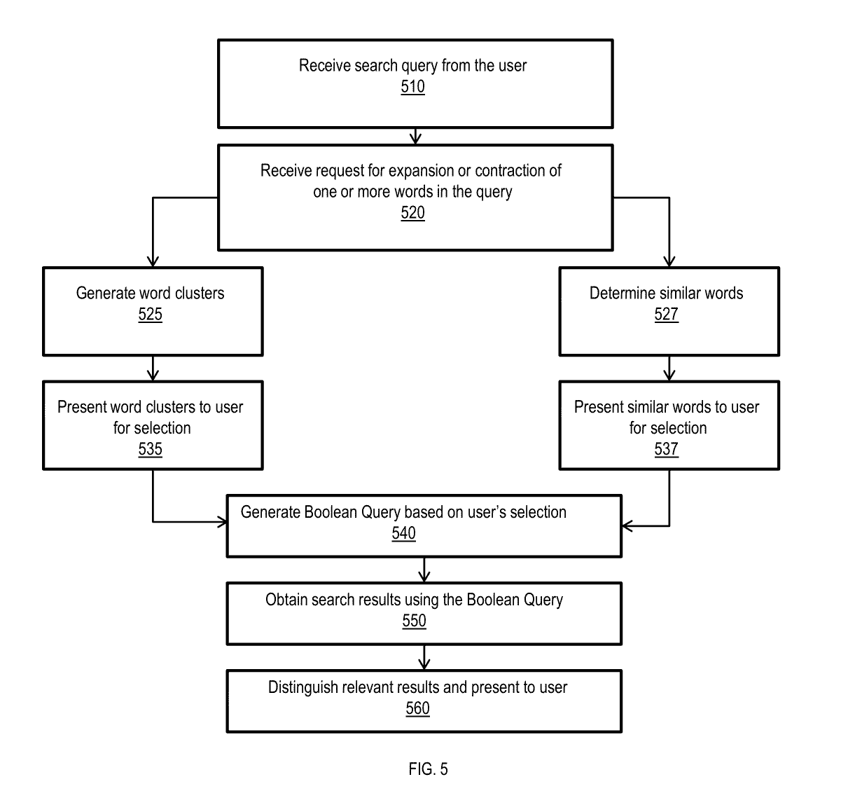

FIG. 5 is a simplified flow diagram of the procedures that may be used by embodiments disclosed herein for assisting a user with conducting a document search and providing the user with her desired search results.

As noted previously, the application server 102 can receive a request from a user for conducting a search 510. The request can be submitted to the application server 102 through a search query 315 entered by the user into the information retrieval application 130. The application server 102 can also receive a request from the user for contraction or expansion of one or more words included in the search query 520.

If extraction is requested, the application server 102 accesses the database 360 to obtain a set of keywords that are most similar to the highlighted word 527. The application server 102 can determine these similar words by utilizing co-occurrence information of words over the entire data corpus. These similar words are forwarded to the information retrieval application 130 for presentation to the user and receiving a selection from the user 537.

If contraction is requested, the application server 102 generates a word network that connects similar words in the database 360 (i.e., words previously processed using the entire data corpus) to the highlighted keyword. Once a word network is organized, the application server 102 can identify clusters of co-occurring words within the network 525. Each cluster of words corresponds to a topic, sub-topic, related concept, or a theme in the analyzed data corpus. The application server 102 communicates representative information for each of the identified word clusters to the information retrieval application 130 for presentation to the user and receiving a selection from the user 535.

The expansion and contraction options allow the application server 102 to arrive at a final Boolean query that can be used to retrieve user's desired results 540. The final Boolean query contains an accurate measure of the user's intent for initiating and conducting the search. The application server 102 uses this Boolean query to obtain the user's desired search results 550. Initially, the maximal query corresponding to the user's intention is executed and a document set potentially containing irrelevant documents is retrieved.

The application server 102 can apply a classification technique to distinguish the results that are relevant to the user's search from the results that may be irrelevant. Any appropriate classifier known in the art can be used to complete the classification process. For example, a support vector machine (SVM) classifier that treats the context indicating word-vectors as support vectors and avoids explicit training can be used.

While the invention has been particularly shown and described with reference to specific illustrative embodiments, it should be understood that various changes in form and detail may be made without departing from the spirit and scope of the invention.

What is claimed is:

1. A computerized method comprising:
receiving a search query from a user;
comparing the search query to digital content collected over a predetermined period of time from one or more digital content generating entities and determining frequency of occurrence of the search query over the collected digital content;
presenting the user with attributes of portions of the collected digital content in which the search query frequently occurs and receiving, from the user, a selection of the presented attributes; and
constructing an updated search query based on the selection of the attribute.

2. The computerized method of claim 1 further including collecting the collected digital content by accessing the one or more digital content generating entities and collecting at least a portion of entire content generated by the digital content generating entities over the predetermined period of time.

3. The computerized method of claim 1 further including analyzing the collected digital content to determine one or more digital text elements with which a given digital text member of collected content often co-occurs.

4. The computerized method of claim 3 further including ranking the one or more digital text elements with which the given digital text member of collected content often co-occurs based on a frequency at which the given digital text and each of the one or more digital text elements co-occur.

5. The computerized method of claim 1 wherein the collected digital content includes at least a portion of a digital text, a digital audio file, a digital image, a digital document, a digital file, or combination thereof.

6. The computerized method of claim 1 wherein determining the frequency of occurrence of the search query over the digital content includes at least one of: determining the frequency at which a text element included in the search query occurs over the collected digital content or determining the frequency at which the text element included in the search query co-occurs with other digital elements of the collected digital content.

7. The computerized method of claim 1 wherein the attributes of portions of the collected digital content presented to the user include at least a segment of digital elements of the portions of the collected digital content with which a text element of the search query frequently co-occurs.

8. The computerized method of claim 1 further including organizing each digital text element of collected digital content into a word network based on at least one of: number of times the digital text element is repeated along with other digital text elements of the collected digital content or based on a word-vector similarity between the digital text element and other digital text elements of the collected digital content.

9. The computerized method of claim 8 wherein nodes of the word network connect similar digital text elements to one another.

10. The computerized method of claim 9 further including identifying clusters of nodes in the word network, the clusters identifying digital text elements used in similar contexts in the collected digital content.

11. The computerized method of claim 10 wherein the attributes of portions of the collected digital content include attributes of the identified clusters and the selection made by the user is arranged to identify one or more clusters that best correspond to the user's search query.

12. The computerized method of claim 1 wherein the updated search query is a Boolean search query constructed based on the selection made by the user.

13. The computerized method of claim 1 further including retrieving one or more pieces of the collected digital content using the updated search query.

14. The computerized method of claim 13 further including distinguishing portions of the retrieved pieces of collected digital content that are relevant to the user's search query from the retrieved pieces.

15. The computerized method of claim 14 further including displaying the relevant portions of the retrieved pieces to the user.

16. A computer program product, tangibly embodied in a non-transitory computer readable storage medium, comprising instructions being operable to cause a data processing system to:
receive a search query from a user;
compare the search query to digital content collected over a predetermined period of time from one or more digital content generating entities and determine frequency of occurrence of the search query over the collected digital content;
present the user with attributes of portions of the collected digital content in which the search query frequently occurs and receive, from the user, a selection of the presented attributes; and
construct an updated search query based on the selection of the attribute.

17. The computer program product of claim 16 further comprising instructions being operable to cause the data processing system to:
access the one or more digital content generating entities;
collect at least a portion of entire content generated by the digital content generating entities over the predetermined period of time;
analyze the collected digital content to determine one or more digital text elements with which a given digital text member of collected content often co-occurs; and
rank the one or more digital text elements with which the given digital text member of collected content often co-occurs based on a frequency at which the given digital text and each of the one or more digital text elements co-occur.

18. The computer program product of claim 16 further comprising instructions being operable to cause the data processing system to determine the frequency of occurrence of the search query over the digital content by at least one of: determining the frequency at which a text element included in the search query occurs over the collected digital content or determining the frequency at which the text element included in the search query co-occurs with other digital elements of the collected digital content.

19. The computer program product of claim 16 wherein the attributes of portions of the collected digital content presented to the user include at least a segment of digital elements of the portions of the collected digital content with which a text element of the search query frequently co-occurs.

20. The computer program product of claim 16 further comprising instructions being operable to cause the data processing system to organize each digital text element of collected digital content into a word network based on at least one of: number of times the digital text element is repeated along with other digital text elements of the collected digital content or based on a word-vector similarity between the digital text element and other digital text elements of the collected digital content.

21. The computer program product of claim 20 wherein nodes of the word network connect similar digital text elements to one another and further comprising instructions being operable to cause the data processing system to identify clusters of nodes in the word network, the clusters identifying digital text elements used in similar contexts in the collected digital content.

22. The computer program product of claim 20 wherein the attributes of portions of the collected digital content include attributes of the identified clusters and the selection made by the user is arranged to identify one or more clusters that best correspond to the user's search query.

23. The computer program product of claim 16 further comprising instructions being operable to cause the data processing system to retrieve one or more pieces of the collected digital content using the updated search query.

24. The computer program product of claim 16 further comprising instructions being operable to cause the data processing system to distinguish portions of the retrieved pieces of collected digital content that are relevant to the user's search query from the retrieved pieces and display the relevant portions of the retrieved pieces to the user.
